(19) United States
(12) Patent Application Publication
(10) Pub. No.: US 2003/0164828 A1
(43) Pub. Date: Sep. 4, 2003

(54) Image processing method, apparatus and system, evaluation method for photographing apparatus, image data storage method, and data structure of image data file

(75) Inventor: Po-Chieh Hung, Tokyo (JP)

Correspondence Address: FRISHAUF, HOLTZ, GOODMAN & CHICK, PC, 767 THIRD AVENUE, 25TH FLOOR, NEW YORK, NY, 10017-2023, US

(73) Assignee: Konica Corporation, Tokyo (JP)

(21) Appl. No.: 10/245,748

(22) Filed: Sep. 17, 2002

(30) Foreign Application Priority Data
Sep. 25, 2001 (JP) 2001-292201

(51) Int. Cl. G06T 15/50

(52) U.S. Cl. 345/426

(57) ABSTRACT

An image processing method for balancing colors of an image on the basis of the principle of the color constancy. The image processing method for processing an image photographed by a photographing apparatus, has: converting a color data of the image photographed by the photographing apparatus under a different type light source, so as to adapt at least one different type light source color data which is a color data for color chips including a chromatic color, under at least one different type light source which is different from a standard light source, against a standard light source color data which is a color data for the color chips under the standard light source.

### BACKGROUND OF THE INVENTION

1. Field of the Invention

The invention relates to an image processing method, an image processing apparatus, an image processing system, an evaluation method for a photographing apparatus, an image data storage method, and a data structure of an image data file. In particular, the invention relates to an image processing method and an image processing apparatus for processing an image photographed by a photographing apparatus, and balancing colors of the image, an evaluation method for evaluating the photographing apparatus used for processing the image according to the image processing method, an image data storage method and an image processing system for storing an image data, and a data structure of an image data file having the image data recorded thereon.

2. Description of Related Art

Conventionally, a method for balancing colors of an image assuming a color adaptation of human beings, is known.

For example, Japanese Patent Application Publication (Unexamined) No. Tokukai-hei 10-126810 discloses a method for converting an image data to tristimulus values (L, M, S) at a retina level of human beings, adjusting the tristimulus values, and having a white balance, assuming a von Kries type adaptation. According to the method, it is possible to have the natural color balance in consideration of the color adaptation of human beings.

For example, there is a case wherein we feel a skin color of human beings incongruous under a light source with a high color temperature, such as a shade during a fine day or the like, or the skin color of human beings looks red under a tungsten light source. Therefore, there is a case wherein we cannot feel colors of an object natural, for example, the skin color of human beings as the object natural, through eyes. The phenomenon shows the imperfection of the color adaptation of human beings.

Further, conventionally, a function which is called a color constancy, is known. The color constancy function is a function of predicting colors of the object under a standard light source (for example, a light source which realizes a day light, or the like), on the basis of colors of the object observed under a different type light source (for example, a shade during a fine day, a tungsten light source or the like) which is different from the standard light source.

Based on the above-described phenomena, in order to balance colors of the image photographed by such an input apparatus as a camera, it is predicted that the colors recognized under the standard light source can be reproduced more effectively and more naturally, by balancing the colors of the image according to the color constancy function than the color adaptation function of human beings.

### SUMMARY OF THE INVENTION

The present invention was developed in view of the above-described problems.

It is an object of the present invention to balance colors of an image on the basis of the principle of the color constancy.

In accordance with a first aspect of the present invention, an image processing method for processing an image photographed by a photographing apparatus, comprises: converting a color data of the image photographed by the photographing apparatus under a different type light source, so as to adapt at least one different type light source color data which is a color data for color chips including a chromatic color, under at least one different type light source which is different from a standard light source, against a standard light source color data which is a color data for the color chips under the standard light source.

Preferably, in the method as described above, the different type light source color data is obtained based on a data concerning spectral sensitivities of the photographing apparatus.

Herein, the photographing apparatus used for processing the image according to the image processing method of the present invention, includes, for example, a camera such as a digital camera, a video camera or the like. The image photographed by the photographing apparatus includes a static image, a moving image or the like. The function of balancing colors of the image is a function of adjusting the color data including the chromatic color of the whole image, so that a white looks white on the image photographed by the photographing apparatus.

The standard light source is a light source which realizes the standard illuminant, and for example, a light source or the like which realizes a day light such as D55 (Daylight 5500K) , D65 (Daylight 6500K) or the like. The different type light source is, for example, a tungsten light source, a fluorescent lamp or the like.

The different type light source color data under the different type light source may be obtained based on spectral sensitivities of the photographing apparatus. That is, the different type light source color data may be specified based on a data concerning the different type light source, for example, spectral distributions or the like of the light source, and a data concerning the color chips, for example, spectral reflectance or the like of the color chips, and further a data concerning the spectral sensitivities of the photographing apparatus, that is, a data affected by the spectral sensitivities of the photographing apparatus. Herein, the color chips include not only actual color chips but also color chips which are prescribed by only spectral data and do not exist. Therefore, the data concerning the color chips includes values obtained when the photographing apparatus actually photographs the color chips, and values calculated based on the spectral sensitivities of the photographing apparatus.

According to the image processing method of the first aspect of the present invention, the color data of the image photographed by the photographing apparatus is converted so as to adapt the color data for the color chips including the chromatic color under the different type light source, that is the different type light source color data, against the color data for the color chips under the standard light source, that is the standard light source color data. That is, the color data of the image photographed by the photographing apparatus is converted so as to adapt against the color data under the standard light source.

Consequently, it is possible to balance colors so as to adjust the color tone of the image photographed by the photographing apparatus to the color tone of the image photographed under the standard light source. That is, it is possible to balance colors of the image on the basis of the principle of the color constancy.

Preferably, in the method of the first aspect of the present invention, the converting a color data of the image is performed so as to minimize a color difference between a result obtained by converting the at least one different type light source color data and the standard light source color data.

According to the above-described method, the color data of the image photographed by the photographing apparatus is converted so as to minimize the color difference between the result obtained by converting the different type light source color data and the standard light source color data. That is, the color data of the image photographed by the photographing apparatus is converted so as to minimize the color difference between the color data and a color data under the standard light source.

Consequently, it is possible to perform the higher accurate image processing on the basis of the principle of the color constancy.

Preferably, in the method of the first aspect of the present invention, the different type light source color data comprises photographed output values obtained when the photographing apparatus actually photographs the color chips including the chromatic color under the at least one different type light source.

According to the above-described method, because the different type light source color data comprises the photographed output values, it is possible to easily specify a means for converting the color data of the image photographed by the photographing apparatus.

As explained in more detail, the means for converting the color data of the image photographed by the photographing apparatus is a means capable of converting the color data of the image so as to adapt the different type light source color data against the standard light source color data, as described in the image processing method of the first aspect of the present invention. On the contrary, the means for converting the color data of the image photographed by the photographing apparatus is a means specified on the basis of the different type light source color data and the standard light source color data, so as to convert the color data of the image so as to adapt the different type light source color data against the standard light source color data.

Herein, according to the method of the first aspect of the present invention, the different type light source color data is specified on the basis of the data including the data concerning the different type light source and the data concerning the color chips, and further the data concerning the spectral sensitivities of the photographing apparatus Consequently, in order to specify the different type light source color data, there occurs a necessity of measuring the spectral sensitivities of the photographing apparatus.

However, according to the above-described method, because the different type light source color data comprises the photographed output values obtained when the photographing apparatus actually photographs the color chips, the different type light source color data is specified in state of including the data concerning the different type light source, the color chips and the spectral sensitivities of the photographing apparatus.

Consequently, it is unnecessary to specify the spectral sensitivities of the photographing apparatus in order to specify the different type light source color data. Further, it is unnecessary to perform an operating processing or the like for calculating the different type light source color data. As a result, it is possible to easily specify the means for converting the color data of the image photographed by the photographing apparatus, on the basis of the actual photographed output values as the different type light source color data in itself.

Preferably, in the method of the first aspect of the present invention, the converting a color data of the image comprises: primary-converting the color data of the image; and adjusting a white balance of a converted color data obtained by primary-converting the color data of the image.

Herein, the primary conversion is a coordinate conversion for converting primary colors (typically, three primary colors) of the color data of the image photographed by the photographing apparatus to another coordinate system. Further, the white balance is a function for mainly adjusting the color data including an achromatic color and approximate colors, so that a white looks white on the converted color data obtained by primary-converting the color data of the image photographed by the photographing apparatus.

According to the above-described method, the white balance is adjusted by converting the converted color data obtained by primary-converting the color data of the image photographed by the photographing apparatus. Consequently, it is possible to adjust the white balance of the image photographed by the photographing apparatus.

Preferably, in the method as described above, the adjusting a white balance of a converted color data comprises gain-adjusting the converted color data.

According to the above-described method, the white balance of the converted color data is adjusted by gain-adjusting the converted color data. Consequently, it is possible to easily adjust the white balance of the image without performing a complex processing to the image photographed by the photographing apparatus.

Preferably, in the method as described above, the primary-converting the color data of the image comprises primary-converting the color data of the image according to a linear matrix.

According to the above-described method, the color data of the image photographed by the photographing apparatus is primary-converted according to the linear matrix. Consequently, when primary-converting the color data of the image, it is unnecessary to perform a complex operating processing or the like to the color data of the image, and it is possible to primary-convert the color data of the image easily.

In accordance with a second aspect of the present invention, an image processing apparatus for processing an image photographed by a photographing apparatus, comprises: a converter for converting a color data of the image photographed by the photographing apparatus under a different type light source, so as to adapt at least one different type light source color data which is a color data for color chips including a chromatic color, under at least one different type light source which is different from a standard light source, against a standard light source color data which is a color data for the color chips under the standard light source.

Preferably, in the apparatus as described above, the different type light source color data is obtained based on a data concerning spectral sensitivities of the photographing apparatus.

According to the image processing apparatus of the second aspect of the present invention, because the apparatus comprises the converter, and the converter converts the color data of the image photographed by the photographing apparatus, the color data of the image is converted by the converter so as to adapt the different type light source color data against the standard light source color data. That is, the color data of the image photographed by the photographing apparatus is converted by the converter, so as to adapt against the color data under the standard light source.

Consequently, it is possible to balance the colors of the image as if the color tone of the image photographed by the photographing apparatus is the color tone of the image photographed under the standard light source. That is, it is possible to balance the colors of the image on the basis of the principle of the color constancy.

Preferably, in the apparatus of the second aspect of the present invention, the converter comprises a color difference minimum converter for converting the color data of the image so as to minimize a color difference between a result obtained by converting the at least one different type light source color data and the standard light source color data.

Preferably, in the apparatus of the second aspect of the present invention, the different type light source color data comprises photographed output values obtained when the photographing apparatus actually photographs the color chips including the chromatic color under the at least one different type light source.

Preferably, in the apparatus of the second aspect of the present invention, the converter comprises: a color data converter for primary-converting the color data of the image; and a white balance adjuster for adjusting a white balance of a converted color data obtained when the color data converter primary-converts the color data of the image.

Preferably, in the apparatus as described above, the white balance adjuster adjusts the white balance of the converted color data by gain-adjusting the converted color data.

Preferably, in the apparatus as described above, the color data converter primary-converts the color data of the image according to a linear matrix.

Preferably, the apparatus of the second aspect of the present invention, further comprises a data storage for storing at least one of a photographed image data photographed by the photographing apparatus and a processed image data obtained when the converter converts the photographed image data, and at least one of a conversion data capable of specifying a converting method that the converter converts the photographed image data to the processed image data and an address data indicating an address of the conversion data.

According to the above-described apparatus, because the apparatus comprises the data storage, in case the conversion data is stored with the photographed image data or the processed image data in the data storage, the apparatus can specify the converting method on the basis of the conversion data, and convert the color data of the photographed image or calculate the image data before being processed based on the processed image data and reconvert the color data of the image data before being processed, according to the specified converting method. Consequently, it is possible to balance the colors of the photographed image or the processed image on the basis of the principle of the color constancy.

Further, in case the address data is stored with the photographed image data or the processed image data in the data storage, the apparatus can specify the conversion data on the basis of the address data, and specify the converting method on the specified conversion data. Consequently, it is possible to balance the colors of the photographed image or the processed image on the basis of the principle of the color constancy, like the case the conversion data is stored in the data storage.

In accordance with a third aspect of the present invention, an evaluation method for a photographing apparatus used for processing an image according to the above-described image processing method, comprises: evaluating the photographing apparatus on the basis of a color difference between a color data obtained by converting the different type light source color data so as to minimize the color difference and the standard light source color data.

According to the evaluation method of the third aspect of the present invention, because the photographing apparatus is evaluated on the basis of the color difference, it is possible to understand which photographing apparatus can perform the higher accurate image processing based on the principle of the color constancy, on the basis of the result of the evaluation. Consequently, it is possible to select a photographing apparatus on the basis of the result of the evaluation for the photographing apparatus, more accurately balance the colors of the image on the basis of the principle of the color constancy, and select the preferable photographing system.

In accordance with a fourth aspect of the present invention, an image data storage method for storing an image data when processing the image according to the image processing method of the first aspect of the present invention, comprises: storing at least one of a photographed image data photographed by the photographing apparatus and a processed image data obtained by converting the photographed image data according to the image processing method, and at least one of a conversion data capable of specifying a converting method for converting the photographed image data to the processed image data and an address data indicating an address of the conversion data.

According to the image data storage method of the fourth aspect of the present invention, at least one of the photographed image data and the processed image data, and at least one of the conversion data and the address data are stored.

Consequently, in case the conversion data is stored with the photographed image data or the processed image data, because the converting method for converting the photographed image data to the processed image data can be specified on the basis of the conversion data, it is possible to convert the photographed image data, or calculate the image data before being processed based on the processed image data and reconvert the image data before being processed, according to the specified converting method. As a result, it is possible to balance the colors of the photographed image or the processed image on the basis of the principle of the color constancy.

Further, in case the address data is stored with the photographed image data or the processed image data, it is possible to specify the conversion data on the basis of the address data, and specify the converting method for converting the photographed image data to the processed image data on the basis of the specified conversion data. As a result, it is possible to balance the colors of the photographed image or the processed image on the basis of the principle of the color constancy, like the case the conversion data is stored.

Preferably, in the method of the fourth aspect of the present invention, the converting the photographed image data comprises primary-converting the photographed image data according to a linear matrix and adjusting a white balance of a converted color data obtained by primary-converting the photographed image data, and the conversion data capable of specifying a converting method for converting the photographed image data to the processed image data comprises at least one of spectral sensitivities of the photographing apparatus and the linear matrix.

According to the above-described method, because the conversion data is at least one of the spectral sensitivities of the photographing apparatus and the linear matrix, it is possible to specify the converting method for converting the photographed image data on the basis of the spectral sensitivities of the photographing apparatus or the linear matrix. Consequently, it is possible to easily perform the processing of balancing the colors of the photographed image or the processed image on the basis of the minimum evident data.

In accordance with a fifth aspect of the present invention, an image processing method for processing the image data stored according to the above-described image data storage method, comprises: specifying the converting method on the basis of at least one of the spectral sensitivities and the linear matrix included in at least one of the conversion data stored according to the image data storage method and the conversion data determined based on the address data; and converting at least one of the photographed image data and the processed image data stored according to the image data storage method, according to the converting method specified.

According to the image processing method of the fifth aspect of the present invention, the converting method is specified on the basis of at least one of the spectral sensitivities and the linear matrix included in the conversion data, and at least one of the photographed image and the processed image data is converted according to the specified converting method.

Consequently, it is possible to balance the colors of the photographed image or the processed image on the basis of the minimum evident data, according to the principle of the color constancy.

In accordance with a sixth aspect of the present invention, an image processing system comprises: a first image processing apparatus comprising a data storage for storing a data, by storing at least one of a processed image data obtained by converting a color data of a photographed image data photographed by a photographing apparatus under a different type light source so as to adapt at least one different type light source color data which is a color data for color chips including a chromatic color, under at least one different type light source which is different from a standard light source against a standard light source color data which is a color data for the color chips under the standard light source, and the photographed image data, and at least one of a conversion data capable of specifying a converting method for converting the photographed image data to the processed image data, and an address data indicating an address of the conversion data; a second image processing apparatus for processing an image, by converting a color data of a photographed image data photographed by a photographing apparatus under a different type light source so as to adapt at least one different type light source color data which is a color data for color chips including a chromatic color, under at least one different type light source which is different from a standard light source against a standard light source color data which is a color data for the color chips under the standard light source; and a transmission medium for exchanging a data between the first image processing apparatus and the second image processing apparatus; wherein the system sends at least one of the photographed image data and the processed image data stored in the data storage, and at least one of the conversion data and the address data stored in the data storage, from the first image processing apparatus to the second image processing apparatus, through the transmission medium.

Preferably, the different type light source color data of the first and second image processing apparatuses are obtained based on data concerning spectral sensitivities of the photographing apparatuses, respectively.

According to the image processing system of the sixth aspect of the present invention, at least one of the photographed image data and the processed image data stored in the data storage of the first image processing apparatus, and at least one of the conversion data and the address data stored with the photographed image data or the processed image data in the data storage, are sent from the first image processing apparatus to the second image processing apparatus through the transmission medium.

Consequently, in case the conversion data is sent with the photographed image data or the processed image data, because the second image processing apparatus can specify the converting method on the basis of the conversion data, it is possible to convert the color data of the photographed image data, or calculate the image data before being processed based on the processed image data and reconvert the color data of the image data before being processed, according to the specified converting method. As a result, it is possible to balance the colors of the photographed image or the processed image on the basis of the principle of the color constancy.

Further, in case the address data is sent with the photographed image data or the processed image data, the second image processing apparatus can specify the conversion data on the basis of the address data, and specify the converting method on the basis of the specified conversion data. As a result, it is possible to balance the colors of the photographed image or the processed image on the basis of the principle of the color constancy, like the case the conversion data is sent with the photographed image data or the processed image data to the second image processing apparatus.

In accordance with a seventh aspect of the present invention, a data structure of an image data file having an image data recorded thereon, comprises: a first data area comprising the image data; and a second data area capable of being referenced by an image processing apparatus, corresponding to any one of a conversion data for converting a color data and an address of the conversion data.

According to the data structure of the seventh aspect of the present invention, because the first data area and the second data area are provided at the image data file, it is possible that the image processing apparatus refers the conversion data or the address of the conversion data corresponding to the second data area, and converts the color data of the image data stored in the first data area, on the basis of the referred conversion data or the conversion data specified based on the referred address, as the occasion may demand.

Preferably, in the data structure of the seventh aspect of the present invention, the conversion data comprises a data for converting at least one different type light source color data which is a color data for color chips including a chromatic color, obtained based on a data concerning spectral sensitivities of a photographing apparatus, under at least one different type light source which is different from a standard light source, so as to adapt against a standard light source color data which is a standard color data for the color chips under the standard light source.

According to the above-described data structure, because the conversion data comprises the data for converting the different type light source color data so as to adapt against the standard light source color data, it is possible that the image processing apparatus balances the colors of the image data stored in the first data area on the basis of the conversion data, according to the principle of the color constancy.

Preferably, in the data structure as described above, the different type light source color data comprises photographed output values obtained when the photographed apparatus actually photographs the color chips including the chromatic color under the different type light source.

According to the above-described data structure, it is possible to easily specify the conversion data for converting the different type light source color data so as to adapt against the standard light source color data.

In accordance with an eighth aspect of the present invention, an image processing method for processing an image photographed by a photographing apparatus, comprises: converting a color data of the image photographed by the photographing apparatus under a different type light source, on the basis of a conversion data capable of converting at least one different type light source color data which is a color data for color chips comprising a chromatic color, obtained based on a data concerning spectral sensitivities of the photographing apparatus, under at least one different type light source which is different from a standard light source, so as to adapt against a standard light source color data which is a color data for the color chips under the standard light source.

### BRIEF DESCRIPTION OF THE DRAWINGS

The present invention will become more fully understood from the detailed description given hereinafter and the accompanying drawing given by way of illustration only, and thus are not intended as a definition of the limits of the present invention, and wherein:

FIG. 1 is a schematic block diagram showing a structure of an image processing apparatus 1 according to a first embodiment of the present invention;

FIGS. 2A and 2B are schematic block diagrams showing examples of an internal structure of an image processing processor 4 of the image processing apparatus 1 shown in FIG. 1;

FIG. 3A is a graph showing spectral sensitivities of a digital camera with a sensitivity A, used for an optimizing processing according to a first exemplary embodiment, and FIG. 3B is a graph showing spectral sensitivities of a digital video camera with a sensitivity B, used for the optimizing processing according to the first exemplary embodiment;

FIG. 4 is a graph showing spectral distributions of light sources selected for the optimizing processing according to the first exemplary embodiment;

FIG. 5 is a graph showing the spectral reflectance of the Macbeth color checker (TM) selected for the optimizing processing according to the first exemplary embodiment;

FIG. 6A is a graph showing results obtained by optimizing the spectral sensitivities shown in FIG. 3A, and FIG. 6B is a graph showing results obtained by optimizing the spectral sensitivities shown in FIG. 3B;

FIG. 7A is a graph showing spectral sensitivities of a cone used as a comparative example according to a second exemplary embodiment of a second embodiment, FIG. 7B is a graph showing results obtained by optimizing the spectral sensitivities shown in FIG. 7A;

FIG. 8 is a table showing the results obtained by optimizing the spectral sensitivities according to the second exemplary embodiment; and

FIG. 9 is a conceptual view showing a data structure of the image data file in which an image data is stored according to an image storage method of a third embodiment.

### PREFERRED EMBODIMENTS OF THE INVENTION

Hereinafter, a preferred embodiment of the present invention will be explained with reference to figures, in detail.

<First Embodiment>

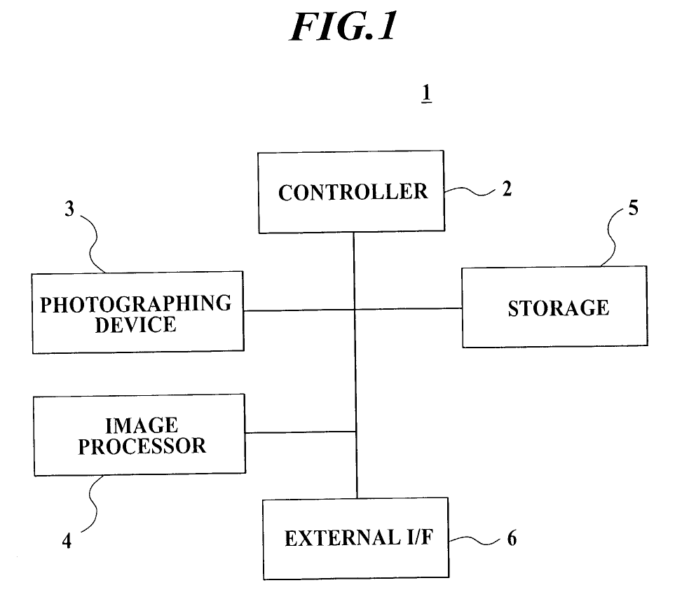

The image processing method according to the first embodiment of the present invention is a method that an image processing apparatus 1 shown in FIG. 1 processes an image. More specifically, the image processing apparatus 1 is, for example, a camera such as a digital camera, a video camera or the like.

The image processing apparatus 1 comprises a controller 2 for controlling the whole image processing apparatus 1, a photographing device 3 as a photographing apparatus for photographing an object and outputting an image signal (image photographed output values), an image processor 4 for processing an image of the object photographed by the photographing device 3, a storage 5 for storing various control programs, data or the like, therein, and an external interface 6 (hereinafter, it will be called “an external I/F”.) for exchanging signals between the image processing apparatus 1 and an external apparatus.

The storage 5 consists of a RAM (Random Access Memory) as an internal storage device, a hard disc apparatus as an external storage device, a floppy (TM) disc which is installed so as to be attached and detached, or the like. For example, the storage 5 stores a control program or a control data of the whole image processing apparatus 1, image data including image signals outputted from the photographing device 3, an image processing program or a control data for making the image processor 4 perform the image processing, image data processed by the image processor 4, or the like, therein.

Further, various types programs and data may be stored in different storages (discs) from each other, or one storage (disc). It is not specially limited how to store the programs and data.

The controller 2 performs a main processing of the image processing apparatus 1. More specifically, for example, the controller 2 performs a processing of storing the image data of the image photographed by the photographing device 3, or the image data processed by the image processor 4 in the storage 5, a processing of sending the data stored in the storage 5 through the external I/F 6 to the external apparatus, a processing of storing the data received from the external apparatus through the external I/F 6 in the storage 5, or the like.

The external I/F 6 exchanges the image data, the control data or the like between the image processing apparatus 1 and the external apparatus, for example, through an USB (Universal Serial Bus), a SCSI (Small Computer System Interface) or the like.

The photographing device 3 comprises a photoelectric element such as a CCD (Charge Coupled Device) or the like. The photoelectric element receives a light from the object, which incidents through a lens which is not shown in figures, through various types filters which are overlaid, provided and not shown in figures, and outputs the image signal such as a RGB (Red-Green-Blue) signal, a CMY (Cyan-Magenta-Yellow) signal or the like, according to the quantity of the received light. For example, each of filters which are overlaid and provided is a three charged coupled device system filter, an one charged coupled device system mosaic filter or the like.

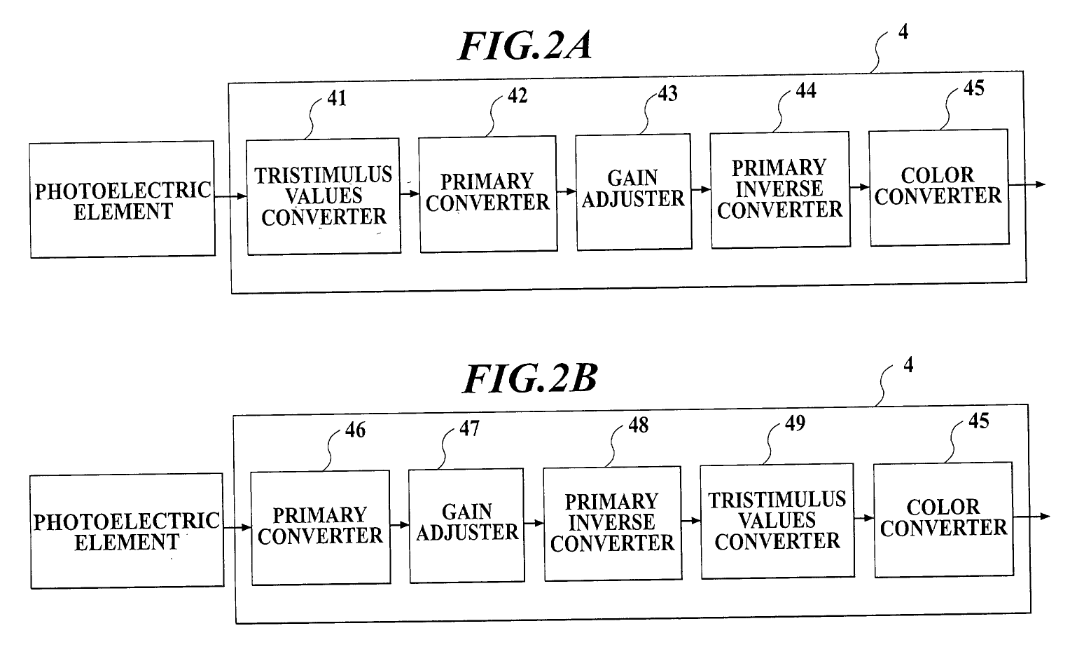

The image processor 4 performs a processing of processing the image signal outputted from the photographing device 3, and balancing the colors represented by the processed image signal against the colors under the standard light source, on the basis of the image processing program stored in the storage 5. FIGS. 2A and 2B show examples of the internal structure of the image processor 4.

As for the example shown in FIG. 2A, the image processor 4 comprises a tristimulus values converter 41, a primary converter 42, a gain adjuster 43, a primary inverse converter 44 and a color converter 45. Herein, the trisimulus values converter 41, the primary converter 42, the gain adjuster 43 and the primary inverse converter 44 correspond to the converter, that is the color difference minimum converter of the present invention.

Herein, “the primary conversion” means to convert the output values outputted from the photographing device 3 to values represented in another coordinate system. Further, “the primary inverse conversion” means to reconvert the values represented in another coordinate system to the values in the original coordinate system.

The tristimulus values converter 41 performs a processing of converting the image signal outputted from the photographing device 3 to the tristimulus values according to a tristimulus values approximate matrix B (hereinafter, it will be called “matrix B”.) for approximating the image signal to the tristimulus values.

Although it is omitted to show in FIG. 2A, in case the filter of the photographing device 3 is an one charged coupled device system, before the tristimulus values converter 41 converts the image signal to the tristimulus values, the image processor 4 performs a color interpolation processing. For example, Japanese Patent Application Publication (Unexamined) No. Tokukai-hei 10-178650 or the like discloses an algorithm for the color interpolation processing. Further, before the tristimulus values converter 41 converts the image signal to the tristimulus values, the image processor 4 adjusts a black level of the image signal.

The primary converter 42 performs a processing of primary-converting the tristimulus values obtained when the tristimulus values converter 41 converts the image signal, and obtaining provisional RGB values (they correspond to the converted color data of the present invention.), according to a primary conversion matrix A (it will be explained, as follows, and hereinafter, it will be called “matrix A”.) which is a linear matrix.

That is, the tristimulus values converter 41 and the primary converter 42 correspond to the color data converter for converting the image signal as the color data of the image photographed by the photographing device 3.

The gain adjuster 43 performs a processing of linear-converting the provisional RGB values obtained when the primary converter 42 primary-converts the tristimulus values, according to a diagonal matrix M. Herein, the diagonal matrix M is a matrix for gain-adjusting the RGB values, and thereby adjusting the white point, so that the achromatic color under the different type light source coincides with the achromatic color under the standard light source. That is, the gain adjuster 43 corresponds to the white balance adjuster for gain-adjusting the provisional RGB values as the converted color data, and keeping the white balance.

Herein, for example, the white point is detected according to a method of determining the total average value of the image to be the white point, or a method of determining the maximum value to be the white point. However, although the method of detecting the white point is not specially limited to these methods, it is possible that the method can adopt a conventionally well-known method.

The primary inverse converter 44 performs a processing of inverse-converting the provisional RGB values obtained when the gain adjuster 43 performs the gain adjusting processing, according to an inverse matrix A⁻¹ of the matrix A used by the primary converter 42, and reconverting to the tristimulus values.

The color converter 45 performs a processing of converting the tristimulus values obtained when the primary inverse converter 44 inverse-converts the provisional RGB values after being gain-adjusted, to the primary (for example, sRGB prescribed in IEC 61966-2-1, or the like) or YCC for the output system such as a CRT (Cathode Ray Tube) or the like.

The processed image data obtained when the image processor 4 processes the image signal is stored in the storage 5 in a state the processed image data is compressed into a compression system such as a JPEG or the like.

Herein, in case an output device which is not shown in figures, such as a display or the like, is provided at the image processing apparatus 1, the image is outputted on the output device on the basis of the image data compressed as described above. Further, in case an external apparatus comprising an output device such as a display or the like is connected to the image processing apparatus 1 through an external I/F 6, and receives the compressed image data through the external I/F 6 from the image processing apparatus 1, the image is outputted on the output device of the external apparatus on the basis of the received image data.

As for the example shown in FIG. 2B, the image processor 4 comprises a primary converter 46, a gain adjuster 47, a primary inverse converter 48 and a tristimulus values converter 49, instead of the tristimulus values converter 41, the primary converter 42, the gain adjuster 43 and the primary inverse converter 44. Herein, the primary converter 46, the gain adjuster 47 and the primary inverse converter 48 correspond to the converter, that is the color difference minimum converter of the present invention.

The primary converter 46 processes a processing of directly primary-converting the image signal outputted from the photographing device 3 according to the matrix A, and calculating provisional RGB values. That is, the primary converter 46 corresponds to the color data converter. Like the case shown in FIG. 2A, the color interpolation processing and the black level adjusting processing processed by the image processor 5 are omitted to be shown in figures.

The gain adjuster 47 processes a processing of adjusting the gain of the provisional image signal obtained when the primary converter 46 primary-converts the image signal, according to the diagonal matrix M. That is, the gain adjuster 47 corresponds to the white balance adjuster.

The primary inverse converter 48 processes a processing of inverse-converting the provisional image signal which is gain-adjusted by the gain adjuster 43, according to the inverse matrix A⁻¹ of the matrix A used by the primary converter 46, and regenerating the image signal.

The tristimulus values converter 49 processes a processing of converting the image signal obtained when the primary inverse converter 48 inverse-converts the provisional image signal which is gain-adjusted, to the tristimulus values according to the matrix B.

The color converter 45 shown in FIG. 2B processes the processing of converting the tristimulus values obtained when the tristimulus values converter 49 converts the processed image signal, to the primary for the output system, like the color converter 45 shown in FIG. 2A.

The data which are optimized and obtained according to the following optimizing processing, are used for the above-described matrixes A and B. The matrixes A and B are previously stored in the storage 5, as the image processing data.

As described above, although two examples of the internal structure of the image processor 4 have been explained with reference to FIGS. 2A and 2B, it is possible to finally obtain the same image data according as the image processor 4 having any one of structures shown in the examples performs the image processing.

Herein, the optimizing processing of the matrixes A and B will be explained before explaining the image processing method. The optimizing processing is executed by an operating apparatus of a well-known personal computer or the like, on the basis of various data which are previously selected.

Each of symbols in the following equations (1) to (5) means a vector matrix. Further, it is omitted to distinguish between each vector matrix and the transposed matrix thereof.

Various data required for the optimizing processing are previously selected arbitrarily.

First, one type light source is selected as a target of the color balance of the image processing apparatus 1, and determined to be the standard light source. The standard light source is a light source which realizes a day light, such as D55 (relative color temperature 5500K), D65 (6500K) or the like, the C light source which is an artificial simulator light source, or the like.

Further, one type or a plurality of types light sources other than the standard light source are selected, and determined to be the different type light source. Although it is preferable to select a typical type light source used when the photographing device 3 photographs, as the different type light source, it is not limited to the above-described light source. It is possible to select an arbitrary type light source. The different type light source is, for example, the A light source (a tungsten light source) supposing a room light source, a black body radiator (a light source with a color temperature of approximate 7500-10000K) considering the shade during the fine day, F1 to F12 light sources supposing a fluorescent lamp of a room, or the like.

Further, color chips including a chromatic color are selected. Herein, although it is preferable to select color chips having the spectral reflectance which approximates the colors of the object (for example, the skin of human beings, the view, or the like) of the photographing device 3, as the color chips, it is not limited to the above-described color chips. It is possible to select arbitrary type color chips.

For example, the color chips means the Macbeth color checker (TM), the Munsell color chips (the Munsell book), spectral reflectance color chips prescribed in CIE13.3, spectral reflectance color chips prescribed in SOCS (JIS-TR X 0012, the standard object color spectral data base for evaluating the color reproduction (SOCS)(1998)), or the like. It is possible to select the color chips (the spectral reflectance color chips as described above, or the like) which are prescribed by only the spectral data and do not include the actual color chips, in only case the spectral sensitivities of the photographing device 3 are known.

After various data required for the optimizing processing are selected, next, when the photographing device 3 actually photographs the selected color chips under each of the standard light source and the different type light sources, it is possible to obtain the output value O of the image signal (corresponding to the photographed output values of the present invention) or the value corresponding to the output value O.

In case the actual color chips are selected as the color chips, the photographing device 3 of the image processing apparatus 1 photographs the actual color chips, and obtains the output value O. Then, when the image processing apparatus 1 sends the output value O to an operating apparatus through the external I/F 6, the operating apparatus side receives the output value O. Herein, in case the filter is an one charged coupled device system, the value after the color is interpolated or the value after the black level is adjusted is determined to be the output value O.

Further, in case the spectral reflectance color chips prescribed by the spectral data are selected as the color chips, the operating apparatus calculates the value corresponding to the output value O, on the basis of the spectral sensitivity Sᵢ of the photographing device 3, the light source spectral intensity L and the color chip spectral reflectance R.

More specifically, for example, in case the D65 light source is selected as the standard light source, and the A light source and the light source having the 9300K black body radiation spectral intensity are selected as the different type light source, the operating apparatus calculates the output value O under each light source according to the following equation (1). Herein, the attached character “ᵢ” indicates the type of the photographing device 3.

[Equation 1]

O_{D65-1}=L_{D65}RSᵢ,O_{9300λ-1}=L_{9300λ}RSᵢ,O_{A-a}=L_{A}RSᵢ (1)

The spectral sensitivity Sᵢ can be measured according to the method of measuring the spectral sensitivities prescribed in the IEC61966-9.

Next, the operating apparatus optimizes the matrixes A and B on the basis of various data which are selected and obtained as described above.

<Optimization of the tristimulus values approximate matrix B>

For example, in case the D65 light source is selected as the standard light source, the tristimulus values T_{D65} of the color chips under the standard light source will be calculated on the basis of the equivalent color function F, according to the following equation (2).

[Equation 2]

T_{D65}=L_{D65}RF (2)

When the average of the color difference ΔE*ab of each color chip is represented as E*ab(α, β), the conversion to the L*a*b* colorimetric specifications system is represented as Lab(T), the calorimetric color reproduction error Ecol of the photographing device 3 is represented according to the following equation (3).

[Equation 3]

Ecol=E*ab(Lab(T),Lab(BO)) (3)

The matrix B is optimized so as to minimize the calorimetric color reproduction error Ecol, according to the equations (2) and (3) in case the actual color chips are selected, or according to the equations (1) to (3) in case the color chips other than the actual color chips are selected.

<Optimization of the primary conversion matrix A>

Herein, the optimizing processing of the matrix A, applied in case the image processor 4 has the internal structure shown in FIG. 2B, will be explained, as follows.

For example, in case the D65 light source is selected as the standard light source, and the A light source and the light source having the 9300K black body radiation spectral intensity are selected as the different type light source, the color constancy predicted error Emccᵢ is represented according to the following equation (4). Herein, the color constancy predicted error Emccᵢ indicates the color difference between the L*a*b* value (the standard light source color data) of the color chips under the standard light source and the L*a*b* value (the different type light source color data) obtained when the output value O of the color chips under the different type light source is converted by the primary converter 46, the gain adjuster 47, the primary inverse converter 48 and the tristimulus values converter 49. The following equation (4) represents an example of the color constancy predicted error Emccᵢ in case the different type light sources are weighted equally.

[Equation 4]

$$\begin{matrix}{Emcc}_{i} = E * ab ( Lab ( {T}_{D65} ) , Lab ( {B}_{i} {A}_{i}^{- 1} {M}_{9300 k \to D65 - i} {A}_{i} {O}_{9300 λ - i} ) ) + \\ E * ab ( Lab ( {T}_{D65} ) , Lab ( {B}_{i} {A}_{i}^{- 1} {M}_{A \to D65 - i} {A}_{i} {O}_{A - i} ) )\end{matrix} \qquad ( 4 )$$

The matrix A is operated continuously and optimized so as to minimize the color constancy predicted error Emccᵢ, according to the optimized matrix B and the equations (2) and (4) in case the actual color chips are selected, or according to the optimized matrix B and the equations (1), (2) and (4) in case the color chips other than the actual color chips are selected.

Herein, the color constancy predicted error Emccᵢ can be generalized according to the following equation (5), in case the type of the different type light source is “j,” the number of types of the different type light source is “N,” and the arbitrary weighted average is “W.”

[Equation 5]

$${Emcc}_{i} = {\sum }_{j = 0}^{N} {w}_{j} E * ab ( Lab ( {T}_{D65} ) , Lab ( {B}_{i} {A}_{i}^{- 1} {M}_{j \to D65 - i} {A}_{i} {O}_{j - i} ) ) \qquad ( 5 )$$

The data of the matrixes A and B which are optimized according to the above-described optimizing processing are previously stored in the storage 5 of the image processing apparatus 1.

Next, the image processing method that the above-described image processing apparatus processes the image will be explained, as follows. Herein, the image processing will be explained in case the image processor 4 has the internal structure shown in FIG. 2A.

First, the photographing device 3 receives the light of the object by the photoelectric element, through the lens and the filter. Then, the photographing device 3 outputs the image signal to the image processor 4, on the basis of the quantity of the received light of the object. In case the filter is an one charged coupled device system, the image processor 4 performs the color interpolation processing and further the black level adjusting processing, to the received image signal.

Next, the tristimulus values converter 41 of the image processor 4 converts the image signal according to the optimized matrix B, and calculates the tristimulus values. Then, the primary converter 42 converts the tristimulus values calculated by the tristimulus values converter 41, according to the optimized matrix B, and calculates the provisional RGB values.

Next, the gain adjuster 43 adjusts the gain of the provisional RGB values calculated by the primary converter 42, according to the diagonal matrix M, and keeps the white balance so that the achromatic color under the different type light source coincides with the achromatic color under the standard light source. Then, the primary inverse converter 44 inverse-converts the provisional RGB values obtained when the gain adjuster 43 performs the gain adjusting processing, according to the inverse matrix A⁻¹ of the optimized matrix A, and reproduces the tristimulus values.

Next, the color converter 45 converts the tristimulus values obtained when the primary inverse converter 44 performs the inverse converting processing, to the primary for the output system. Then, when the image processor 4 compresses the image data processed as described above, the storage 5 stores the compressed image data therein.

As described above, in accordance with the image processing method according to the first embodiment of the present invention, and the image processing apparatus 1 used for executing the image processing method, the tristimulus values converter 41, the primary converter 42, the gain adjuster 43 and the primary inverse converter 44 shown in FIG. 2A, or the primary converter 46, the gain adjuster 47 and the primary inverse converter 48 shown in FIG. 2B, convert the image signal of the photographed image, according to the primary conversion matrix A which is optimized so as to convert the output value O concerning the color chips including the chromatic color under the different type light source, or the value corresponding to the output value O so that it coincides with the color tone of the color chips under the standard light source.

Therefore, the colors of the image photographed by the photographing device 3 are balanced against the color tone of the image photographed under the standard light source. Accordingly, it is possible to balance the colors of the image on the basis of the principle of the color constancy, according to the image processing method and the image processing apparatus 1 of the first embodiment.

Further, because the image data is processed according to the matrix A which is optimized on the basis of the output value O of the photographing device 3, determined based on the spectral sensitivities of the photographing device 3, or the value corresponding to the output value O, it is possible to perform the image processing suitable for the spectral characteristic of the photographing device 3 by itself, that is, the spectral sensitivities of the photographing device 3.

Further, because the matrix which is optimized so as to minimize the color constancy predicted error is used for the matrix A, the image signal of the image photographed by the photographing device 3 is converted so as to minimize the color difference between the colors of the image signal and the color tone the image under the standard light source. Consequently, it is possible to perform the high accurate image processing on the basis of the color constancy principle.

Further, because the image data converting processing is performed according to the optimized matrix A and the diagonal matrix M (gain adjusting), it is possible to properly balance the colors, regardless of the type of the light source when the photographing device 3 photographs. Consequently, even if the matrix A is not determined for every light source when the photographing device 3 photographs, it is possible to perform the image processing according to the change of the color temperature of the light source.

Further, in case the actual color chips are selected as the color chips in the optimizing processing, the matrix A is optimized on the basis of the output value O obtained when the photographing device 3 photographs the actual color chips. In case the spectral reflectance color chips prescribed by the spectral data are selected as the color chips, the matrix A is optimized on the basis of the value corresponding to the output value O, obtained when the operating apparatus calculates on the basis of the spectral sensitivities of the photographing device 3.

Therefore, in case the actual color chips are selected as the color chips, differently from the case the spectral reflectance color chips are selected as the color chips, it is unnecessary to measure the spectral sensitivities of the photographing device 3, and perform the processing of calculating the value corresponding to the output value O. Consequently, as compared with the case the spectral reflectance color chips prescribed by the spectral data are selected as the color chips, it is possible to perform the optimizing processing of the matrix A more easily.

Further, because the image processor 4 comprises the gain adjuster 43 or 47, the gain adjuster 43 or 47 adjusts the white balance of the provisional RGB values obtained when the primary converter 42 or 46 performs the converting processing. Consequently, it is possible that the image processor 4 adjustments the white balance of the image.

Furthermore, because the white balance adjustment is performed by the gain adjustment, it is possible that the image processor adjustments the white balance of the image easily, without performing a complex processing.

Further, because each of the tristimulus values converter 41 or 49, the primary converter 42 or 46, the gain adjuster 43 or 47, and the primary inverse converter 44 or 48 of the image processor 4 has the structure of linear-converting the image signal according to the linear matrix, and processing the data, it is possible to easily perform the converting processing of the image signal, without performing a complex operating processing or the like, in the image processing.

According to the first embodiment, although the case has been explained as an example, that the tungsten light source and the high color temperature light source (9300K black body radiator) are selected as the different type light source, and weighted equally, and the matrix A is optimized according to the equation (4), it is not limited to the case. The selected light sources including the typical fluorescent lamp or the like may be weighted properly, and the matrix A may be optimized according to the equation (5).

Further, the image processing apparatus 1 comprising the photographing device 3 is not limited to the structure for providing only one matrix A for the image processing apparatus 1. The image processing apparatus 1 may have the structure for storing a plurality of types of matrixes A such as a plurality of matrixes A optimized in case of changing the weighted averages of the different type light source having a lower color temperature than the standard light source and the different type light source having a higher color temperature than the standard light source, a matrix A optimized only for the different type light source which is a fluorescent lamp (for example, a F2 light source) having a low color rendering property, or the like, in the storage 5, and changing the matrix A used for the image processing according to the photographing environment.

For example, the image processing apparatus 1 may have a structure comprising a light source determining means for detecting a flicker or a luminance line, detecting an attachment of an apparatus such as a strobe, a cover or the like, or recognizing a chroma or a hue of a specific color chip, and thereby determining the light source when photographing, an input device for manually inputting the light source when photographing, or the like. If the image processing apparatus 1 comprises the structure, it is possible to perform a proper image processing suitable for the environment when photographing, by automatically changing the matrix A on the basis of the type of the light source when photographing, detected or inputted.

Further, the image processing apparatus 1 may have the structure for determining the type of the light source when photographing, suitably weight-averaging on the basis of the type, recalculating the matrix A, and performing the image processing on the basis of the recalculated matrix A.

Two examples of the internal structure of the image processor 4 are shown in FIGS. 2A and 2B. In case the photographing device 3 has four or more than four colors spectral sensitivities, it is preferable that the image processor 4 has the internal structure shown in FIG. 2B.

For example, in case the sensor (photoelectric element) of the photographing device 3 has N types (ch_{N}1-ch_{N}N), and the image processor 4 has the internal structure shown in FIG. 2B, the image processing apparatus 1 performs the following processing (1) to (6).

(1) The sensors ch_{N}1 to ch_{N}N obtain images 1 to N.

(2) The primary converter 46 converts the images 1 to N obtained by the processing (1) to proper primaries, according to the optimized N×N matrix A, and obtains images 1′ to N′.

(3) The gain adjuster 47 detects white color points (image values for the object (gray) having the constant spectral reflectance) on the basis of the images 1′ to N′ obtained by the processing (2), and determines the values to be W1 to WN The method for determining the W1 to WN is not limited to the above-described processing. For example, the image processing apparatus 1 may comprise a sensor other than the sensors photographing the object, the sensor may measure an illuminant directly, and the gain adjuster 47 may calculate the W1 to WN on the basis of the output values from the sensor.

(4) The gain adjuster 47 adjusts the gain of the images 1′ to N′ so as to balance against the image data photographed under the standard light source, according to the DMT (diagonal matrix transform) as the N×N diagonal matrix M, on the basis of the W1 to WN obtained by the processing (3), and obtains images 1″ to N″.

(5) The primary inverse converter 48 inverse-primary-converts the images 1″ to N″ obtained by the processing (4), and obtains images 1″′ N″′.

(6) The tristimulus values converter 49 optimizes the images 1″′ to N″′ obtained by the processing (5), to the tristimulus values.

The above-described processing (1) to (6) are approximately like the processing for removing the illuminant element and measuring the spectral reflectance of the object.

As described above, in case the image processor 4 has the internal structure shown in FIG. 2B, the gain is adjusted according to the N×N diagonal matrix M by the processing (4). On the other hand, in case the image processor 4 has the internal structure shown in FIG. 2A, even if the photographing device 3 has four or more than four color spectral sensitivities, because the tristimulus values converter 41 converts the image data to three parameters, the gain is adjusted according to the 3×3 diagonal matrix M.

Accordingly, the image processor 4 can adjust the wider range according to the diagonal matrix M, and adjust the white balance more accurately, in the case of having the internal structure shown in FIG. 2B than the case of having the internal structure shown in FIG. 2A.

Further, the color data of the present invention, means general data for specifying the color. More specifically, for example, the color data includes the above-described output data O, the tristimulus values T, the L*a*b* values or the like. However, the color data is not limited to the examples. For example, the color data may be stimulus values in another colorimetric specifications system, or the like.

Further, although the matrix A is a matrix which is optimized so as to minimize the color constancy predicted error Emccᵢ, it is unnecessary that the matrix A is determined so as to minimize the color constancy predicted error Emccᵢ. For example, even if the matrix A is determined so as to reduce the color constancy predicted error Emccᵢ to some extent, it is possible to adjust the color balance on the basis of the principle of the color constancy.

Further, although the image processing apparatus 1 is a camera such as a digital camera or the like, the image processing apparatus is not specially limited to the camera, and may be an apparatus for processing photographed images. Furthermore, the photographing device 3 may be provided at not the image processing apparatus 1 but another apparatus. More specifically, for example, the photographing device 3 may be provided at a digital camera which does not perform the image processing, and the image processor 4 of the image processing apparatus 1 may be provided at a personal computer or the like.

Further, it should also understood that the structure of the image processing apparatus 1 and the content of each processing of the image processing method may be changed within the limits of claims of the present invention, as the occasion may demand.

[First Exemplary Embodiment]

Next, the exemplary embodiment of the above-described optimizing processing will be explained.

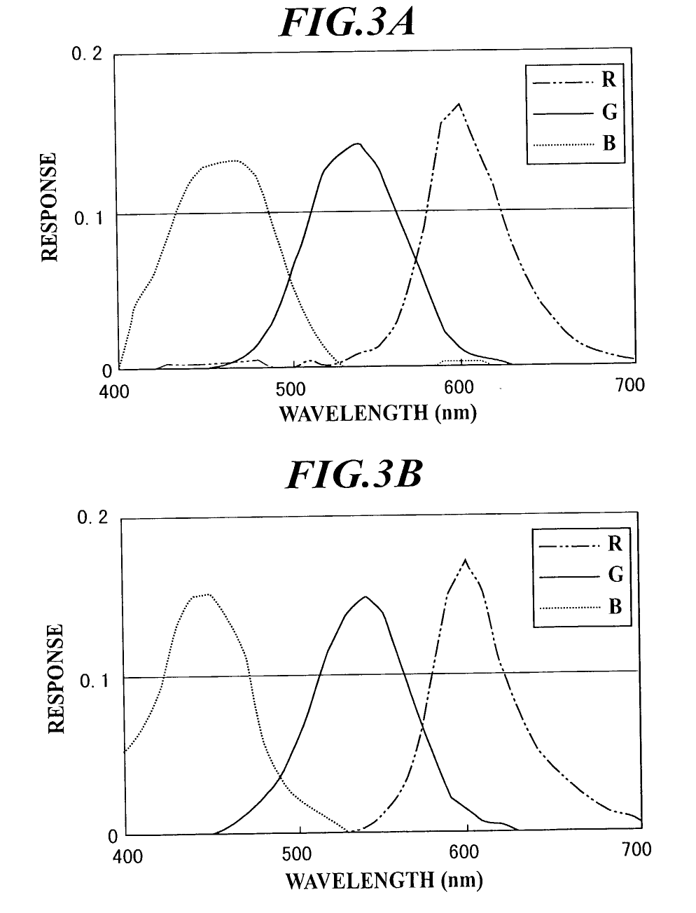

The optimizing processing will be explained, regarding each of the digital camera (hereinafter, it will be called “the camera with the sensitivity A”.) having the spectral sensitivities shown in the graph of FIG. 3A, and the digital video camera (hereinafter, it will be called “the camera with the sensitivity B”.) having the spectral sensitivities shown in the graph of FIG. 3B.

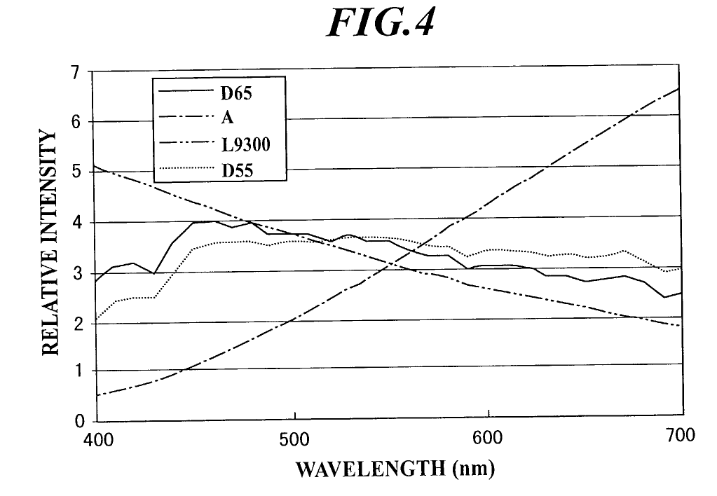

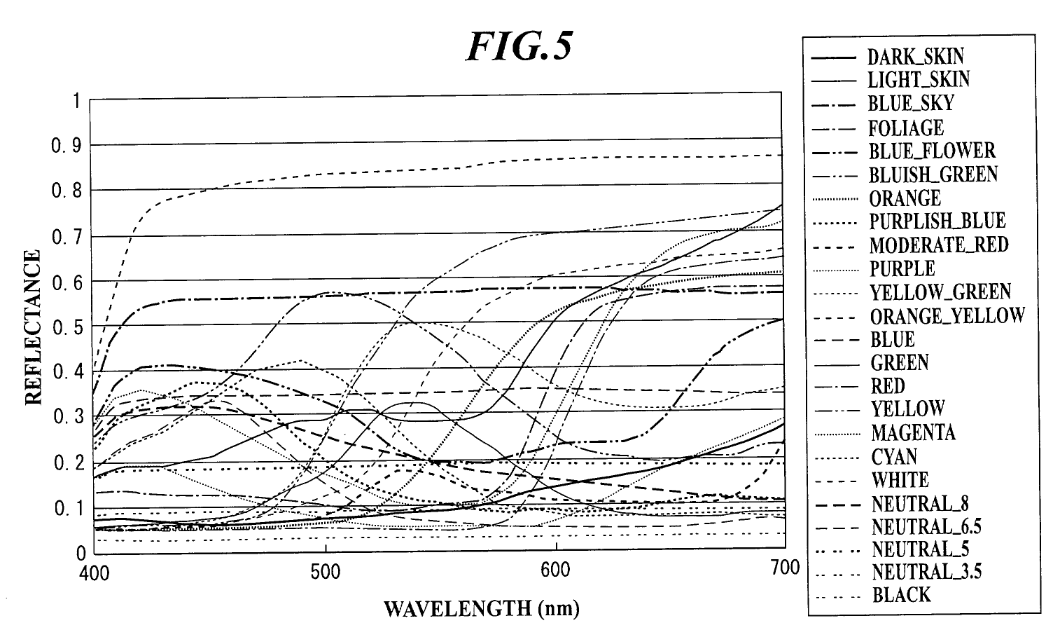

According to the optimizing processing, the D65 light source is selected of light sources shown in the graph of FIG. 4, as the standard light source. Further, the A light source and the L9300K light source (the light source having the 9300K black body radiation spectral intensity) are selected of light sources shown in the graph of FIG. 4, as the different type light source. Further, the Macbeth color checker (TM) shown in the graph of FIG. 5 is selected as the color chips.

Then, when each of the camera with the sensitivity A and the camera with the sensitivity B photographs the actual color chips of the Macbeth color checker (TM) under each of the D65 light source, the A light source and the L9300K light source, the output values O are obtained. The tristimulus values approximate matrix B is optimized so as to minimize the calorimetric color reproduction error Ecol, on the basis of the output values O, according to the equations (2) and (3). Further, the primary conversion matrix A is optimized so as to minimize the color constancy predicted error Emccᵢ, according to the equations (2) and (4).

Therefore, each linear conversion coefficient used for the conversion of the image signal is obtained on the basis of the result of the above-described optimizing processing. Hereinafter, linear conversion equations (6) to (9) for converting the image signal of the camera with the sensitivity B are shown as an example.

The following equation (6) is an equation for primary-converting the image signals ch1 to ch3, according to the optimized matrix A.

[Equation 6]

$$[ \begin{matrix}{ch1}^{′} \\ {ch2}^{′} \\ {ch3}^{′}\end{matrix} ] = [ \begin{matrix}0.011085 & - 0.04337 & 1.058985 \\ 0.385694 & - 0.04082 & 0.011953 \\ - 0.06343 & 2.083069 & - 0.14606\end{matrix} ] \cdot [ \begin{matrix}ch1 \\ ch2 \\ ch3\end{matrix} ] \qquad ( 6 )$$

The following equation (7) is an equation for gain-adjusting image signals ch1′ to ch3′ obtained by the equation (6), after the primary conversion, according to the diagonal matrix M. Herein, the diagonal matrix shown in the equation (7) is the diagonal matrix M so that the white point of the A light source coincides with the white point of the D65 light source.

[Equation 7]

$$[ \begin{matrix}{ch1}^{″} \\ {ch2}^{″} \\ {ch3}^{″}\end{matrix} ] = [ \begin{matrix}3.322761 & 0 & 0 \\ 0 & 0.64347 & 0 \\ 0 & 0 & 1.209468\end{matrix} ] \cdot [ \begin{matrix}{ch1}^{′} \\ {ch2}^{′} \\ {ch3}^{′}\end{matrix} ] \qquad ( 7 )$$

The following equation (8) is an equation for inverse-converting image signals ch1″ to ch3″ obtained by the equation (7), after the gain adjustment, according to the inverse matrix A⁻¹ of the optimized matrix A.

[Equation 8]

$$[ \begin{matrix}{ch1}^{″′} \\ {ch2}^{″′} \\ {ch3}^{″′}\end{matrix} ] = [ \begin{matrix}- 0.0224 & 2.601678 & 0.05052 \\ 0.065734 & 0.077536 & 0.482949 \\ 0.947227 & - 0.02406 & 0.019252\end{matrix} ] \cdot [ \begin{matrix}{ch1}^{″} \\ {ch2}^{″} \\ {ch3}^{″}\end{matrix} ] \qquad ( 8 )$$

The following equation (9) is an equation for converting image signals ch1″′ to ch3″′ obtained by the equation (8), after the inverse conversion, to the tristmulus values, according to the optimized matrix B.

[Equation 9]

$$[ \begin{matrix}{ch1}^{″′} \\ {ch2}^{″′} \\ {ch3}^{″′}\end{matrix} ] = [ \begin{matrix}0.67752 & 0.172672 & 0.148261 \\ 0.320201 & 0.679428 & - 0.00698 \\ - 0.02644 & 0.050903 & 1.016228\end{matrix} ] \cdot [ \begin{matrix}{ch1}^{″} \\ {ch2}^{″} \\ {ch3}^{″}\end{matrix} ] \qquad ( 9 )$$

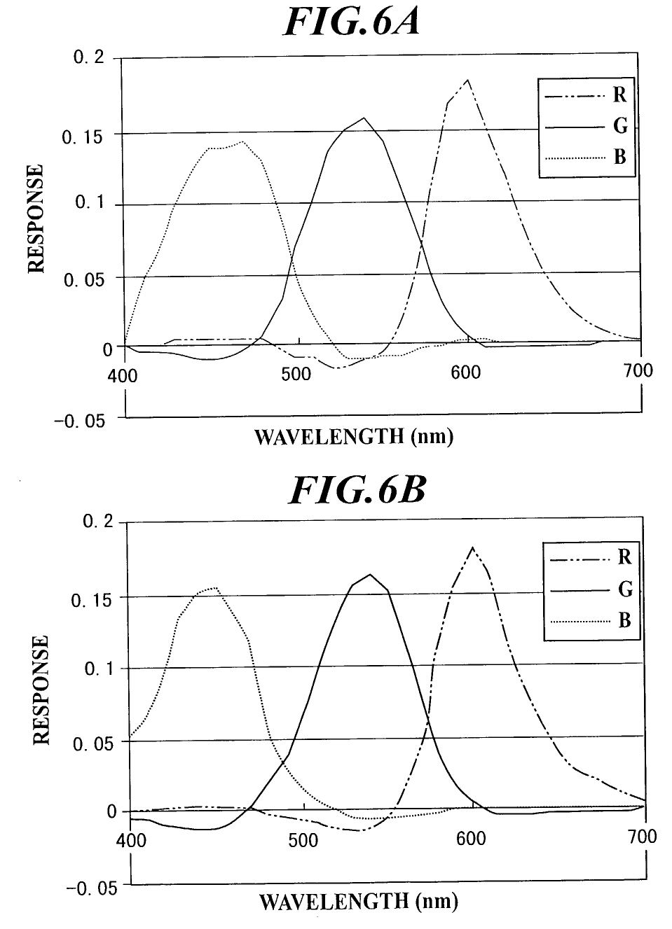

Further, the spectral sensitivities of the cameras shown in the graphs of FIGS. 3A and 3B are primary-converted on the basis of the results of the optimizing processing, and thereby the optimized spectral sensitivities are calculated, respectively. The results are shown in FIGS. 6A and 6B.

<Second Embodiment>

The evaluation method for the photographing apparatus according to the second embodiment of the present invention is a method for evaluating the photographing device 3 of the image processing apparatus 1, on the basis of (1) the calorimetric color reproduction error, (2) the minimum color constancy predicted error and (3) the noise quantity. It is characteristic of the present invention to evaluate the photographing device 3 on the basis of (2) the minimum color constancy predicted error, specially.

First, regarding the photographing device 3 as the evaluated object, the operating apparatus or the like calculates (1) the colorimetric color reproduction error, (2) the minimum color constancy predicted error and (3) the noise quantity.

(1) the colorimetric color reproduction error

The optimized colorimetric color reproduction error Ecol is calculated by the optimizing processing according to the tristimulus values approximate matrix B described in the first embodiment.

(2) the minimum color constancy predicted error

The optimized color constancy predicted error Emccᵢ (the minimum color constancy predicted error) is calculated by the optimizing processing according to the primary conversion matrix A descried in the first embodiment.

(3) the noise quantity

The minute range of deviation of each color for the input value (0.184) corresponding to L*=50, that is, the standard deviation (eight points in total) of the L*a*b* when each color moves only by ±a, is calculated regarding each direction of L*, a* and b*. The RMS (Root mean square) is calculated as the noise quantity.

Herein, the value of “a” is, for example, 0.005 when the input maximum value is 1.

Further, the noise quantity is represented by the ratio when the Estevez-Hunt-Pointer primary is 100%. The Estevez-Hunt-Pointer primary is determined to be standard, because it is understood that it is approximately the cone's sensitivity of eyes of human beings.

The photographing device 3 is evaluated on the basis of the colorimetric color reproduction error, the minimum color constancy predicted error and the noise quantity calculated as described above.

As described above, in accordance with the evaluation method for the photographing apparatus according to the second embodiment, the photographing device 3 is evaluated on the basis of the above-described calorimetric color reproduction error, the minimum color constancy predicted error and the noise quantity. Accordingly, it is possible to determine that the photographing device 3 having the smaller calorimetric color reproduction error, the smaller minimum color constancy predicted error and the smaller noise quantity can perform the higher accurate image processing, on the basis of the result of the evaluation. Consequently, it is possible to select the photographing device 3 on the basis of the result of the evaluation.

Herein, there is a case wherein the result of the evaluation based on the colorimetric color reproduction error is contrary to the result of the evaluation based on the minimum color constancy predicted error. In the case, when the photographing device 3 having the smallest minimum calorimetric color reproduction error is selected on the basis of the results, it is possible to perform the higher accurate color balance adjustment on the basis of the principle of the color constancy.

Further, although three values of the calorimetric color reproduction error, the minimum color constancy predicted error and the noise quantity are calculated and compared with values of another photographing device respectively, according to the second embodiment, it is always unnecessary to calculate all three values. When at least the minimum color constancy predicted error is calculated and compared with the value of another photographing device, it is possible to know which photographing device 3 is proper when performing the image processing on the basis of the principle of the color constancy.

[Second Exemplary Embodiment]

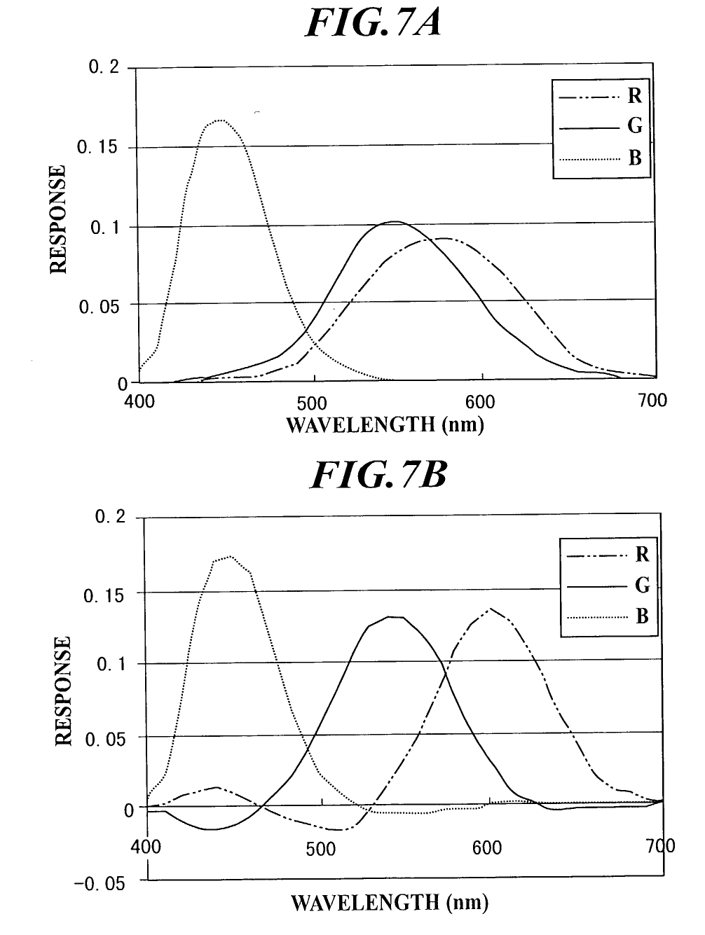

The calorimetric color reproduction error, the minimum color constancy predicted error and the noise quantity of each of the camera with the sensitivity A and the camera with the sensitivity B are calculated on the basis of the results of the optimizing processing according to the above-described first embodiment. Further, in order to compare, the optimizing processing like the first embodiment is performed to the spectral sensitivities (Estevez-Hunt-Pointer Primary) of the cone shown in the graph of FIG. 7A. Then, the calorimetric color reproduction error, the minimum color constancy predicted error and the noise quantity of the cone are calculated on the basis of the results of the optimizing processing. FIG. 7B is a graph showing the spectral sensitivities optimized by primary-converting the spectral sensitivities of the cone shown in the graph of FIG. 7A.

Further, in order to refer, the color constancy predicted error is calculated in case of balancing the color (the white) according to the primary based on the spectral sensitivities which are not optimized and left as it is, regarding each of the camera with the sensitivity A, the camera with the sensitivity B and the cone. More specifically, the color constancy predicted error is calculated according to the above-described equation (4), in case the matrix A is a unit matrix.

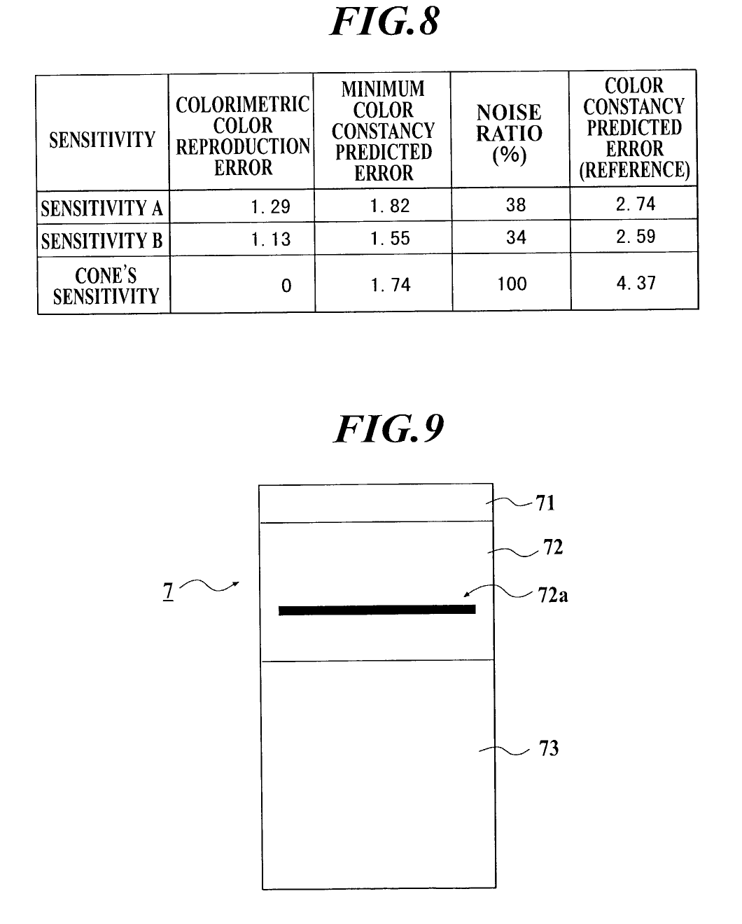

FIG. 8 is a table showing the calculated results as described above. The ratio of the minimum color constancy predicted error obtained when the spectral sensitivities are optimized to the color constancy predicted error (reference) obtained when the spectral sensitivities are not optimized, is 66% in case of the camera with the sensitivity A, or 60% in case of the camera with the sensitivity B. Accordingly, it is understood that the camera with the sensitivity B can reproduce the colors under the standard light source on the basis of the colors under the different type light source according to the image processing method of the first embodiment, more accurately, than the camera with the sensitivity A.

Further, when the calorimetric color reproduction errors and the noise ratios are compared with each other between the camera with the sensitivity A and the camera with the sensitivity B, the calorimetric color reproduction error and the noise ratio of the camera with the sensitivity B show lower values than the calorimetric color reproduction error and the noise ratio of the camera with the sensitivity A, respectively. Consequently, it is possible to be understood that the higher accurate image processing can be performed when not the camera with the sensitivity A but the camera with the sensitivity B is selected.

<Third Embodiment>

The method for storing image data according to the third embodiment of the present invention is a method that the image processing apparatus 1 constructing the image processing system which is not shown in figures stores the image data. The image processing system comprises the image processing apparatus 1 (first image processing apparatus) according to the first embodiment, an external apparatus (second image processing apparatus) and a transmission medium for exchanging data between the image processing apparatus 1 and the external apparatus.

The controller 2 of the image processing apparatus 1 stores the image data compressed by the image processor 4, for example, in the format of the file structure 7 shown in FIG. 9, in the storage 5. The image data compressed by the image processor 4 corresponds to the image data processed according to the image processing method of the present invention. The file structure 7 corresponds to the data structure of the image data file of the present invention. The storage 5 corresponds to the data storage of the present invention.

The file structure 7 comprises a file header block 71, a metadata block 72 for storing data common to the image data, and an image data storage block 73 (corresponding to the first data area of the present invention) for storing the image data in themselves. The metadata block 72 comprises a conversion data storage block 72a (corresponding to the second data area of the present invention). The conversion data storage block 72a stores the data of the optimized primary conversion matrix A, the data (corresponding to the conversion data of the present invention) of the spectral sensitivities of the photographing device 3 when photographing images, or the like, therein.

Further, the controller 2 can send all data included in the file structure 7 stored in the storage 5, to the external apparatus through the transmission medium, at the same time.

The external apparatus constructing the image processing system comprises an image processor having the structure like the image processor 4 according to the first embodiment. Further, the external apparatus comprises a storage for storing an image processing program for making the image processor perform the image processing, image processing data or the like.

The transmission medium constructing the image processing system consists of, for example, a cable, a LAN (Local Area Network), a telephone line, the Internet, or the like.

The image data storage method performed by the above-described image processing apparatus 1 will be explained, as follows.

When the image processor 4 performs the image processing as described according to the first embodiment, the controller 2 makes the storage 5 store the compressed image data in the format of the file structure 7 shown in FIG. 9. At the same time, the controller 2 makes the conversion data storage block 72a store the data of the optimized matrix A or the data of the spectral sensitivities of the photographing device 3 when photographing images, which is previously stored in the storage 5.

Next, the image processing method performed by the external apparatus will be explained in case the external apparatus receives the data of the file structure 7 from the image processing apparatus 1 through the transmission medium.

The external apparatus reads the data of the matrix A out of the conversion data storage block 72a of the file structure 7 received from the image processing apparatus 1. Then, the image processor of the external apparatus inverse-converts the processed image data included in the file structure 7, on the basis of the data of the matrix A, and thereby calculates the data after the gain adjustment processing. More specifically, the image processor of the external apparatus performs the inverse conversion of the conversion processing by the color converter and the inverse conversion of the conversion processing by the primary inverse converter, in case of having the internal structure like the image processor 4 shown in FIG. 2A. On the other hand, the image processor performs the inverse conversion of the conversion processing by the color converter, the inverse conversion of the conversion processing by the tristimulus values converter and the inverse conversion of the conversion processing by the primary inverse converter, in case of having the internal structure like the image processor 4 shown in FIG. 2B.

Next, the gain controller of the external apparatus adjusts the gain of the calculated data after the gain adjustment, and readjusts the white balance of the data. Thereafter, the image processor of the external apparatus converts the image data the white of which is rebalanced by the primary inverse converter and the color converter, in case of having the internal structure like the image processor 4 shown in FIG. 2A. On the other hand, the image processor of the external apparatus converts the image data the white of which is rebalanced by the primary inverse converter, the tristimulus values converter and the color converter, in case of having the internal structure like the imager processor 4 shown in FIG. 2B.

Further, the external apparatus reads the data of the spectral sensitivities of the photographing device 3 out of the conversion data storage block 72a of the file structure 7 received from the image processing apparatus 1. Then, the image processor of the external apparatus performs the optimizing processing of the matrix A as described according to the first embodiment, on the basis of the data of the spectral sensitivities. Thereafter, the image processor of the external apparatus performs the inverse conversion, the white balance adjustment and the converting processing of the image data, on the basis of the matrix A calculated by the optimizing processing, like the case the matrix A is stored in the conversion data storage 72a.

As described above, in accordance with the image data storage method, the image processing apparatus 1, the image processing system and the file structure 1 according to the third embodiment, it is possible that the external apparatus reads out the data of the matrix A or the spectral sensitivities, stored in the conversion data storage 72a, and optimizes and reprocesses the compressed image data according to the color constancy on the basis of the data.

Specifically, in case the image processing apparatus 1 side adjusts the white balance automatically, there is a possibility that the error is included in the processed image. In the case, because the external apparatus can adjust the white balance again, it is possible to obtain the higher quality image.

Further, because the data of the matrix A or the spectral sensitivities are stored in the conversion data storage 72a, the external apparatus can reprocess the image data on the basis of the minimum evident data. Consequently, it is possible to reduce the load on the operating processing when reprocessing the image data. Further, it is possible to reduce the data quantity of the whole file structure 7.

Further, according to the third embodiment, when the image data stored in the image data storage block 73 of the file structure 7 has the structure so as to have the larger number of bits (for example, 10 to 16 bits) than the number of bits (for example, 8 bits) used at the output step, it is possible to avoid the overflow of the bits when recalculating.

Further, although the image data storage block 73 stores the image data after the image processing therein, the image data storage block 73 is not limited to it. The image data storage block 73 may store the data (corresponding to the photographed image data of the present invention) before the image processing such as the original data of the image signal obtained when the photographing device 3 photographs, the tristimulus values data converted from the original data, or the like. In the case, the image processor of the external apparatus can process the data before the image processing, on the basis of the data of the matrix A or the spectral sensitivities of the photographing device 3, stored in the conversion data storage block 72a, and adjust the color balance on the basis of the principle of the color constancy.

Further, although the conversion data storage block 72a stores the data of the matrix A or the spectral sensitivities of the photographing device 3 therein, the conversion data storage block 72a is not limited to it. For example, the data of the matrix A or the spectral sensitivities may be previously stored in the arbitrary location on the internet, and the conversion data storage block 72a may store the data (corresponding to the address data of the present invention) giving the address of the location, and in particular, for example, the URL (Uniform Resource Locator) or the like, therein.

According to the structure, because the external apparatus side can search out the data of the matrix A or the spectral sensitivities on the basis of the address data, it is possible that the external apparatus performs the conversion processing of the image data or the reconversion processing of the processed image data, on the basis of the searched out data.

Further, in case the storage 5 storing the file structure 7 of the image data is, for example, a storage medium such as a floppy (TM) disc or the like, which can be attached to and detached from the image processing apparatus 1 side, when the storage medium which can be attached and detached, is equipped with the external apparatus, it is possible that the external apparatus reads the data of the file structure 7 out of the storage medium, and performs the image processing on the basis of the read data. In the case, it is always unnecessary that the external apparatus is connected to the image processing apparatus 1 through the transmission medium.

Further, it is always unnecessary that the image processing apparatus 1 according to the third embodiment, comprises the image processor 4. The reason is that the external apparatus side can adjust the color balance according to the optimized matrix A, on the basis of the principle of the color constancy.

According to the present invention, the following effects will be indicated.

As described above, the color data of the image photographed by the photographing apparatus is converted so that the different type light source color data coincides the standard light source color data. That is, the color data of the image photographed by the photographing apparatus is converted so as to adapt against the color data under the standard light source. Consequently, it is possible to balance the colors as if the color tone of the image photographed by the photographing apparatus is the color tone of the image photographed under the standard light source. That is, it is possible to balance the colors of the image on the basis of the principle of the color constancy.

The entire disclosure of Japanese Patent Application No. Tokugan 2001-292201 filed on Sep. 25, 2001 including specification, claims, drawings and summary are incorporated herein by reference in its entirety.

What is claimed is:

1. An image processing method for processing an image photographed by a photographing apparatus, comprising:
converting a color data of the image photographed by the photographing apparatus under a different type light source, so as to adapt at least one different type light source color data which is a color data for color chips including a chromatic color, under at least one different type light source which is different from a standard light source, against a standard light source color data which is a color data for the color chips under the standard light source.

2. The method of claim 1, wherein the converting a color data of the image is performed so as to minimize a color difference between a result obtained by converting the at least one different type light source color data and the standard light source color data.

3. The method of claim 1, wherein the different type light source color data comprises photographed output values obtained when the photographing apparatus actually photographs the color chips including the chromatic color under the at least one different type light source.

4. The method of claim 1, wherein the converting a color data of the image comprises: primary-converting the color data of the image; and adjusting a white balance of a converted color data obtained by primary-converting the color data of the image.

5. The method of claim 4, wherein the adjusting a white balance of a converted color data comprises gain-adjusting the converted color data.

6. The method of claim 4, wherein the primary-converting the color data of the image comprises primary-converting the color data of the image according to a linear matrix.

7. The method of claim 1, wherein the different type light source color data is obtained based on a data concerning spectral sensitivities of the photographing apparatus.

8. An image processing apparatus for processing an image photographed by a photographing apparatus, comprising:
a converter for converting a color data of the image photographed by the photographing apparatus under a different type light source, so as to adapt at least one different type light source color data which is a color data for color chips including a chromatic color, under at least one different type light source which is different from a standard light source, against a standard light source color data which is a color data for the color chips under the standard light source.

9. The apparatus of claim 8, wherein the converter comprises a color difference minimum converter for converting the color data of the image so as to minimize a color difference between a result obtained by converting the at least one different type light source color data and the standard light source color data.

10. The apparatus of claim 8, wherein the different type light source color data comprises photographed output values obtained when the photographing apparatus actually photographs the color chips including the chromatic color under the at least one different type light source.

11. The apparatus of claim 8, wherein the converter comprises: a color data converter for primary-converting the color data of the image; and a white balance adjuster for adjusting a white balance of a converted color data obtained when the color data converter primary-converts the color data of the image.

12. The apparatus of claim 11, wherein the white balance adjuster adjusts the white balance of the converted color data by gain-adjusting the converted color data.

13. The apparatus of claim 11, wherein the color data converter primary-converts the color data of the image according to a linear matrix.

14. The apparatus of claim 8, wherein the different type light source color data is obtained based on a data concerning spectral sensitivities of the photographing apparatus.

15. The apparatus of claim 8, further comprising a data storage for storing at least one of a photographed image data photographed by the photographing apparatus and a processed image data obtained when the converter converts the photographed image data, and at least one of a conversion data capable of specifying a converting method that the converter converts the photographed image data to the processed image data and an address data indicating an address of the conversion data.

16. An evaluation method for a photographing apparatus used for processing an image according to the image processing method of claim 2, comprising:
evaluating the photographing apparatus on the basis of a color difference between a color data obtained by converting the different type light source color data so as to minimize the color difference and the standard light source color data.

17. An image data storage method for storing an image data when processing the image according to the image processing method of claim 1, comprising:
storing at least one of a photographed image data photographed by the photographing apparatus and a processed image data obtained by converting the photographed image data according to the image processing method, and at least one of a conversion data capable of specifying a converting method for converting the photographed image data to the processed image data and an address data indicating an address of the conversion data.

18. The method of claim 17,
wherein the converting the photographed image data comprises primary-converting the photographed image data according to a linear matrix and adjusting a white balance of a converted color data obtained by primary-converting the photographed image data, and
the conversion data capable of specifying a converting method for converting the photographed image data to the processed image data comprises at least one of spectral sensitivities of the photographing apparatus and the linear matrix.

19. An image processing method for processing the image data stored according to the image data storage method of claim 18, comprising:
specifying the converting method on the basis of at least one of the spectral sensitivities and the linear matrix included in at least one of the conversion data stored according to the image data storage method and the conversion data determined based on the address data; and
converting at least one of the photographed image data and the processed image data stored according to the image data storage method, according to the converting method specified.

20. An image processing system comprising:
a first image processing apparatus comprising a data storage for storing a data, by storing at least one of a processed image data obtained by converting a color data of a photographed image data photographed by a photographing apparatus under a different type light source so as to adapt at least one different type light source color data which is a color data for color chips including a chromatic color, under at least one different type light source which is different from a standard light source against a standard light source color data which is a color data for the color chips under the standard light source, and the photographed image data, and at least one of a conversion data capable of specifying a converting method for converting the photographed image data to the processed image data, and an address data indicating an address of the conversion data;
a second image processing apparatus for processing an image, by converting a color data of a photographed image data photographed by a photographing apparatus under a different type light source so as to adapt at least one different type light source color data which is a color data for color chips including a chromatic color, under at least one different type light source which is different from a standard light source against a standard light source color data which is a color data for the color chips under the standard light source; and
a transmission medium for exchanging a data between the first image processing apparatus and the second image processing apparatus;
wherein the system sends at least one of the photographed image data and the processed image data stored in the data storage, and at least one of the conversion data and the address data stored in the data storage, from the first image processing apparatus to the second image processing apparatus, through the transmission medium.

21. The system of claim 20, wherein the different type light source color data of the first and second image processing apparatuses are obtained based on data concerning spectral sensitivities of the photographing apparatuses, respectively.

22. A data structure of an image data file having an image data recorded thereon, comprising:
a first data area comprising the image data; and
a second data area capable of being referenced by an image processing apparatus, corresponding to any one of a conversion data for converting a color data and an address of the conversion data.

23. The data structure of claim 22, wherein the conversion data comprises a data for converting at least one different type light source color data which is a color data for color chips including a chromatic color, obtained based on a data concerning spectral sensitivities of a photographing apparatus, under at least one different type light source which is different from a standard light source, so as to adapt against a standard light source color data which is a standard color data for the color chips under the standard light source.

24. The data structure of claim 23, wherein the different type light source color data comprises photographed output values obtained when the photographed apparatus actually photographs the color chips including the chromatic color under the different type light source.

25. An image processing method for processing an image photographed by a photographing apparatus, comprising:
converting a color data of the image photographed by the photographing apparatus under a different type light source, on the basis of a conversion data capable of converting at least one different type light source color data which is a color data for color chips including a chromatic color, obtained based on a data concerning spectral sensitivities of the photographing apparatus, under at least one different type light source which is different from a standard light source, so as to adapt against a standard light source color data which is a color data for the color chips under the standard light source.
